(19) United States
(12) Patent Application Publication
(10) Pub. No.: US 2009/0291849 A1
(43) Pub. Date: Nov. 26, 2009

(54) CATALYST CARRIER BODY WITH PASSIVATION LAYER

(75) Inventors: Alfred Reck, Kurten (DE); Markus Mengelberg, Overrath (DE); Michael Voit, Leverkusen (DE); Ferdi Kurth, Mechernich (DE); Kait Althofer, Wiehl (DE)

Correspondence Address: LERNER GREENBERG STEMER LLP, P O BOX 2480, HOLLYWOOD, FL, 33022-2480, US

(73) Assignee: EMITEC GESELLSCHAFT FUR EMISSIONSTECHNOLOGIE, Lohmar (DE)

(21) Appl. No.: 12/535,221

(22) Filed: Aug. 4, 2009

Related U.S. Application Data
(62) Division of application No. 11/108,480, filed on Apr. 18, 2005.
Application No. 11/108,480 is a continuation of application No. PCT/EP2003/011503, filed on Oct. 17, 2003.

(30) Foreign Application Priority Data
Oct. 18, 2002 (DE) 102 51 624.3

(51) Int. Cl. B01J 32/00

(52) U.S. Cl. 502/439

(57) ABSTRACT

A catalyst carrier body includes at least one housing, a honeycomb body and a passivation layer which includes a multiplicity of separate crystal agglomerations with an averaged height lying in the range of 0.3 to 1.5 μm. Various production methods are proposed which are suitable, in particular, for producing such catalyst carrier bodies. Thus, the formation of the passivation layer takes place by the blending and/or mixing of an adhesive with a passivating substance and subsequently applying the adhesive, or by roughening a region using a blast-cutting manufacturing method with corundum particles being employed as the blasting medium. A barrier is thereby provided in a very simple and cost-effective way which, for example during the formation of brazed connections, prevents the then liquid brazing material from being distributed beyond the desired tying regions as a result of capillary effects.

### CROSS-REFERENCE TO RELATED APPLICATIONS

This is a divisional of U.S. application Ser. No. 11/108,480, filed Apr. 18, 2005, which was a continuation, under 35 U.S.C. § 120, of copending International Application No. PCT/EP03/11503, filed Oct. 17, 2003, which designated the United States; the application also claims the priority, under 35 U.S.C. § 119, of German patent application 102 51 624.3, filed Oct. 18, 2002; the prior applications are herewith incorporated by reference in their entirety.

### BACKGROUND OF THE INVENTION

### Field of the Invention

The present invention relates to a catalyst carrier body which includes at least one housing with an inside, as well as a honeycomb body. The invention also relates to a method for producing a catalyst carrier body. Such catalyst carrier bodies are used, in particular, for the cleaning of exhaust gases of mobile internal combustion engines such as, for example, gasoline or diesel engines in motor vehicle engineering.

Catalyst carrier bodies in motor vehicle construction are conventionally provided with a carrier layer (in particular a wash coat) which is distinguished by a very large surface and is conventionally impregnated with at least one catalytically active material (for example, platinum, rhodium or the like). When contact occurs between the exhaust gas and those catalytically active materials, a reduction in the pollutants, such as, for example, carbon monoxide, unsaturated hydrocarbons, nitrogen monoxide, etc., which are contained in the exhaust gas, takes place. In order, from the outset, to provide a relatively large surface of the carrier layer, the catalyst carrier bodies are conventionally constructed as honeycomb bodies which have a multiplicity of passages through which a fluid (in particular, exhaust gas) is capable of flowing. Ceramic, extruded and metallic honeycomb bodies are known in that context. The honeycomb bodies are generally introduced into a housing which, in turn, is integrated directly into the exhaust pipe of, for example, a passenger car. In a mobile exhaust system of that type, the catalyst carrier body is exposed to high thermal and dynamic loads.

The thermal loads result, for example, on one hand, from the temperature of the exhaust gas itself, which temperature increases when the catalyst carrier body is disposed nearer to the internal combustion engine. On the other hand, chemical catalytic conversion also leads to a rise in temperature of the catalyst carrier body, since that conversion generally proceeds exothermally, so that, under certain circumstances, temperatures are reached which are markedly higher than the exhaust gas temperature itself (up to 1300° C.). The important factors with regard to dynamic loads arise as a result of the combustion process and of external vibration excitations. Since the combustion process in the internal combustion engine takes place intermittently, the pressure pulses resulting therefrom are propagated periodically through the exhaust system. External vibration excitation occurs, for example, due to unevennesses of a road over which the motor vehicle is moving.

Due to such high thermal and dynamic loads, a permanent connection of the honeycomb body to the housing is particularly expedient. On one hand, the connection must be suitable for compensating for a different thermal expansion behavior of the honeycomb body relative to the housing (precisely with regard to the time after a new start or a restart of the internal combustion engine) and, on the other hand, a detachment of the honeycomb body from the housing must be avoided in the long term.

In this respect, reference may be made first to a method for producing a honeycomb body which may be gathered from International Publication No. WO 99/37896, corresponding to U.S. Pat. Nos. 6,425,517, 6,497,039 and 6,634,542. Those disclosures state that the honeycomb body and the casing tube have a differing thermal expansion behavior due to their different material properties and because of different temperatures during operation. The aim, therefore, is to avoid a rigid connection between the honeycomb body and the casing tube at least at one end region of the honeycomb body or, in any event, in defined partial regions. For that reason, the encased honeycomb body described in International Publication No. WO 99/37896, corresponding to U.S. Pat. Nos. 6,425,517, 6,497,039 and 6,634,542, is constructed with a sleeve which, in spite of manufacturing tolerances of the casing tube and of the honeycomb body, is intended to ensure that direct brazed connections between the honeycomb body and the casing tube in the at least one end region of the honeycomb body are avoided. Further embodiments of such sleeves may also be gathered, for example, from International Publication No. WO 01/79670, corresponding to U.S. Patent Application Publication No. US 2003/0007906 and International Publication No. WO 01/53668, corresponding to U.S. Patent Application Publication No. US 2003/0021740. The contents of the disclosures of the above-mentioned documents is fully incorporated herein.

Precisely with regard to the use of metallic honeycomb bodies and of a permanent tying or connection into a metallic housing, it is further known to make the connection of the honeycomb body to the housing through an intermediate layer which is connected on its inside to the honeycomb body and at its outside to the housing. Such an intermediate layer may be gathered, for example, from Japanese Patent Publication JP 04-222636 A. The intermediate layer is constructed therein as a corrugated metal sheet and is connected, on one hand, to the honeycomb body and, on the other hand, to the housing. In that case, it is stated that the corrugated metal sheet can experience deformation in the event of a radial expansion of the honeycomb body. In order to ensure such a deformation, it is proposed therein that a connection of the corrugated metal sheet to the honeycomb body not be disposed in the same cross section as a connection to the housing. Under those circumstances, an expansion and contraction of the honeycomb body in the axial direction would also be ensured.

Further, what may be referred to as contraction limiters are known from German Published, Non-Prosecuted Patent Application DE 101 37 897 A1, corresponding to U.S. Patent Application Publication No. US 2004/0152595 A1. Reference to the contents of the disclosure thereof is made fully herein. The at least one contraction limiter, which is disposed between the honeycomb body and the housing, causes an outwardly directed tension on at least part of the honeycomb body, so that the mean initial diameter of the matrix during and/or after thermal stress decreases by at most 5%, preferably even only by at most 2%. In that respect, it is explained that, because of the different cooling behavior in edge regions and in core regions, known metallic honeycomb bodies no longer assume their original, in particular cylindrical configuration after repeated thermal alternating stress but, instead, reduce their volume and have a, for example, barrel-like contour. The result thereof, in particular, is that, between the matrix and the housing, a relatively large annular gap is formed, through which, particularly during operation of the honeycomb body in the exhaust system of an internal combustion engine, the uncleaned exhaust gas flows, and, consequently, effective cleaning according to the statutory regulations cannot be ensured. The above-mentioned contraction limiters serve for compensating for or preventing such a barrel-like contour of the honeycomb body.

In all of those configurations of a catalyst carrier body, it is particularly important to define exactly the connection regions required for that purpose between the honeycomb body and the housing or between the honeycomb body and the sleeve or between the sleeve and the housing. In particular, in production, care must be taken to ensure that, for example during the brazing of the components disposed adjacently one another, a flow of brazing material into portions outside the desired connection regions is prevented. For that purpose, for example, measures are known which prevent a connection of metal surfaces during high-temperature processing (such as, for example, sintering or brazing). Those measures mostly contain fine ceramic particles which are applied to the corresponding surface through the use of a binder. The binder is volatile at even relatively low temperatures. That substance is also known, inter alia, as brazing material stop.

Reference may be made at this juncture, in particular, to International Publication No. WO 01/79669, corresponding to U.S. Pat. No. 6,673,466 and U.S. Patent Application Publication No. US 2003/0049484, the contents of the disclosures of which are likewise fully incorporated into the description herein. Those disclosures describe a production method for a catalyst carrier body. The housing is constructed, in at least one portion of an inner wall, with a passivation layer for the controlled prevention of a brazed connection to the honeycomb body. The passivation layer in that case takes the form of a surface oxide layer, in particular of a ceramic application layer. In order to produce such a passivation layer, it is proposed to heat the housing selectively, in a spatially limited manner, heat it inductively and treat it chemically and to apply the ceramic layer to the housing through the use of flame spraying. The alternatives, disclosed therein, for producing such a passivation layer, have proven very appropriate in the past, but in that case it is a predominant requirement that the housing be subjected to additional thermal treatment. That is unfavorable, for example in terms of production costs, since there has to be passage through a multiplicity of different processing stations, and under certain circumstances, in turn, standstill times are necessary during which the component is heated or cooled.

### SUMMARY OF THE INVENTION

It is accordingly an object of the invention to provide a catalyst carrier body with a passivation layer and a method for producing the same, which overcome the hereinafore-mentioned disadvantages of the heretofore-known devices and methods of this general type, in which the catalyst carrier body can be produced by a simple and cost-effective procedure that is careful in terms of the material used, which ensures exactly delimited connection regions of components of the catalyst carrier body that are to be connected to one another and in which production methods make it possible, without a high outlay in technical terms, to provide passivation layers in desired regions, while also using as small an amount of passivating materials as possible.

With the foregoing and other objects in view there is provided, in accordance with the invention, a catalyst carrier body, comprising at least one housing having an inside, a honeycomb body connected to the inside of the at least one housing by technical joining in a tying region, and at least one passivation layer delimiting the tying region. The passivation layer includes a multiplicity of separate crystal agglomerations with an averaged height lying in a range of 0.3 to 1.5 μm.

It is accordingly proposed herein that the region in which a tying together of the housing and the honeycomb body is to be prevented not be covered completely by a unitary sheet-like passivation layer, but instead an open-pored rough fissured passivation layer is formed. This has several advantages, for example, only a small amount of material of the passivation medium (such as, for example, Al₂O₃) needs to be used. Furthermore, concentration differences which are generated on the surface in a controlled manner are, for example, conducive to a diffusion and oxidation of aluminum contained in the metal of the housing and/or of the honeycomb body. In this case, it is particularly advantageous if a multiplicity of crystal agglomerations are delimited and spaced apart from one another, in particular to such an extent that the distance from the adjacent crystal agglomeration is greater than its height.

In accordance with another feature of the invention, the crystal agglomerations are disposed on the inside of the housing or on at least one sleeve which is positioned between the housing and the honeycomb body. The inside of the housing or the sleeve is preferably roughened in the region of the passivation layer. A thus fissured surface of the passivation region can thereby also be achieved in terms of series manufacture with a high degree of process reliability.

With the objects of the invention in view, there is also provided a method for producing a catalyst carrier body, which comprises providing at least one housing having an inside, and providing a honeycomb body. A region of the inside of the housing and/or the honeycomb body is roughened using a blast-cutting manufacturing method with corundum particles employed as a blasting medium. The honeycomb body is inserted into the housing and technical joining connections are formed.

With the objects of the invention in view, there is additionally provided a method for producing a catalyst carrier body, which comprises providing at least one housing with an inside, providing at least one sleeve, and providing a honeycomb body. A region of the sleeve is roughened using a blast-cutting manufacturing method with corundum particles employed as a blasting medium. The at least one sleeve is introduced into the housing or the at least one sleeve is placed around the honeycomb body. The honeycomb body is inserted into the housing and technical joining connections are formed.

The manufacturing method of blast-cutting has proved particularly appropriate in tests due to its flexible possibilities of use. In blast-cutting, cutting grains are thrown loosely onto a processing location. Since the action of the cutter is governed mainly by the kinetic energy of the grain, the active principle of cutter engagement is energy-bound. It is preferable in this case to use corundum particles, in particular with a size of 10 μm to 20 μm, which are blasted through the use of an energy carrier, by the pressure or centrifugal method, onto the surface to be treated. The use of corundum particles has the advantage that at least fractions of the particles themselves settle on the surface of the blasting component or are conducive, on the surface, to a diffusion and oxidation of aluminum contained in the metal. Therefore, as a rule, no further operation is required in order to apply another or further material having a passivating action in this region. As a rule, through the use of an appropriate blast nozzle, all of those regions of the housing, of the honeycomb body and/or of the sleeve which are relevant in this case can easily be reached even fully automatically. This method is consequently highly suitable for series production which, for example in motor vehicle construction, is customary in the production of catalyst carrier bodies.

With the objects of the invention in view, there is furthermore provided a method for producing a catalyst carrier body, which comprises providing at least one housing with an inside, and providing a honeycomb body. An adhesive is blended and/or mixed with a passivating substance. The adhesive having the passivating substance is applied to the inside of the housing. The honeycomb body is inserted into the housing and technical joining connections are formed.

An important aspect, in this case, is the use of an adhesive which at the same time has a passivating substance. Adhesive of this type is applied to the inside of the housing in order to fix the honeycomb body within the housing, so that it is subsequently possible to introduce into the honeycomb structure or between the housing and the honeycomb structure the substances which serve for forming the desired technical joining connections. Thus, in particular, the adhesive differs from the known binders in that the adhesive primarily has the function of fixing the honeycomb structure at least temporarily in the housing, that is to say not only providing a bonding action between the passivating layer and the surface. The preferred manner of producing the technical joining connection is by brazing. However, a sintering process or even welding may be used as well.

The need for prior fixing arises, in particular, with regard to honeycomb bodies which have a plurality of at least partially structured metal foils. Conventionally, these metal foils are coiled, wound and/or stacked spirally, in an S-shaped or U-shaped manner or in a similar way. This “loose” stack of metal foils is subsequently introduced into the housing through the use of a corresponding device, in which case it is particularly important that the relative configuration of the metal foils which has been produced is substantially preserved. This preservation of the relative configuration of the metal foils is important precisely also with regard to subsequent manufacturing processes, since in this case, for example, the supply of adhesive and/or brazing material is carried out “by contact”. That is to say, the above-mentioned substances, as a rule, are not sprayed on, but are applied or introduced at least partially by contact of an applicator device with the metal foils. Since, in this respect, it is not possible to ensure that uniform contacting of all of the metal foils takes place simultaneously, the composite structure or stack of metal foils is protected against a mutual displacement of the metal foils through the use of the adhesive proposed herein.

In addition to the function of fixing the honeycomb body in early phases of the production process, the adhesive makes it possible, moreover, to generate a passivation layer. For this purpose, it is necessary that the adhesive action of the adhesive recedes into the background, preferably even disappears completely, in a later phase of the production process. It is necessary, however, at least to ensure that, in the finished catalyst carrier body, the adhesive action of the adhesive is significantly lower than the connecting forces of the technical joining connections, so that the resulting adhesive connections do not cause any tensions between the honeycomb body and the housing in the event of a relative movement of these components.

After the adhesive has substantially lost its adhesive action, a passivation layer is formed at the corresponding location on the inside of the housing. The passivation layer, for example, prevents subsequently applied and heated brazing material from settling in this region. In this respect, it is particularly advantageous to provide the adhesive having the passivating substance in a portion which at least partially delimits the region in which the technical joining connections are subsequently to be made. Accordingly, the first provisional fixing of the honeycomb body within the housing initially takes place in a portion other than that where the technical joining connections are ultimately disposed. The method proposed herein can be carried out particularly simply and cost-effectively even within the framework of series manufacture. In particular, long travels of the semifinished product are avoided since, for example, transports toward furnaces and/or storage depots are avoided. Furthermore, the combination of the proposed adhesive with a passivating substance makes it possible to form passivation layers which subsequently ensure that the technical joining connections are present in actual fact only in the region which has been configured in terms of the thermal and dynamic loads of the catalyst carrier body.

In accordance with another mode of the invention, the passivating substance is pulverulent, and it is preferably aluminum oxide, in particular with a mean grain diameter of 0.3 to 1.5 μm. Aluminum oxide has already proven appropriate in the past as “brazing material stop”. The mean grain diameter proposed herein proved particularly suitable in previous tests, since a virtually closed layer was formed in this case, along with a subsequent evaporation of the adhesive. The passivation layer produced therefore has no “free zones” in which, for example, the metal of the housing is exposed and is therefore a possible point for the formation of technical joining connections. Alternatively or in combination therewith, it is also expedient, under certain circumstances, to use other refractory metal oxides such as, for example, zirconium oxide, magnesium oxide or the like.

It may also be mentioned, in this respect, that the volume fraction of the passivating substance in the adhesive is at least 40%, in particular at least 60%, and preferably at least 75%. A higher volume fraction of the passivating substance is to be selected, in particular, when the portion, on which the adhesive is disposed, on the inside of the housing, has a relatively large construction, and/or when the honeycomb body is constructed with a relatively small volume. The term “small volume” means, in this context, that the honeycomb body has a volume (honeycomb structure including passages) which is, for example, smaller than 1 l (liter), in particular 0.7 l, preferably smaller than 0.5 l and, particularly preferably, smaller than 0.3 l. It may also be explained, in addition, that “mean” grain diameter means an average value which characteristically describes the grain fraction conventionally used (with, for example, a Gaussian distribution of the grain diameters).

In accordance with a further mode of the invention, placed between the housing and the honeycomb body is at least one sleeve which is preferably first laid around the honeycomb body and subsequently, together with the latter, introduced at least partially into the housing. In this embodiment of the catalyst carrier body, the latter includes at least three separate components which must be disposed in a defined position in relation to one another before they can be provided with adhesive and brazing material which ultimately make the technical joining connections to the components with one another. For the formation of technical joining connections between the housing and the sleeve and/or the sleeve and the honeycomb body, band-shaped brazing material strips are often used, which are fixed to the sleeve even before the sleeve is inserted into the housing. In view of the problems initially mentioned with regard to the coordination of the technical joining connections with the thermal and dynamic loads on the catalyst carrier body, it is particularly important that this sleeve maintains the desired position in relation to the housing or in relation to the honeycomb body until the time when the technical joining connections are actually formed. For this purpose, the adhesive having a passivating substance is applied on the inside of the housing and/or the outer or inner surface area of the sleeve, so that an undesirable displacement of the components in relation to one another is ruled out. With regard to the configuration of the adhesive on the sleeve, the procedure must, in general, be similar to that already explained further above with regard to the inside of the housing and to the position in relation to the technical joining connections. With regard to the configuration of such a sleeve, reference may be made to International Publication No. WO 01/79670, corresponding to U.S. Patent Application Publication No. US 2003/0007906 and International Publication No. WO 01/53668, corresponding to U.S. Patent Application Publication No. US 2003/0021740, already mentioned above.

In accordance with an added mode of the invention, the adhesive is applied on the inside of the housing in the form of a strip, in particular so as to run completely around and preferably with a width of less than 10 mm. Where a strip-shape of the structure is concerned, the adhesive may be disposed on the inside of the housing in one or more portions which, for example, extend substantially or approximately in the axial direction. Alternatively and/or additionally thereto, however, these portions may also be constructed to run around in the circumferential direction, in particular to run around completely, so as to form virtually a ring-shaped barrier. With regard to the axial extent of the portion in which the adhesive is disposed or the passivation layer is subsequently formed, a range of 5 mm to 50 mm is preferred. The passivation layer resulting therefrom has, for example, a thickness of 80 μm to 120 μm.

In accordance with an additional mode of the invention, in order to form the technical joining connections, the insertion of the honeycomb body into the housing first takes place only partially, and bonding agent and/or pulverulent brazing material is then introduced by way of at least one end face of the catalyst carrier body. With regard to the detailed description of such a supply of bonding agent and/or pulverulent brazing material, reference is made to German Published, Non-Prosecuted Patent Application DE 101 51 487 C1, corresponding to U.S. Pat. No. 6,811,071, the contents of which are fully incorporated herein by reference. In this case, it may also be explained that the bonding agent primarily has only the function of settling on the components to be connected and of at least temporarily fixing the brazing material subsequently supplied. A considerable bonding action for fixing the components themselves is not at the forefront, so that a marked difference from the properties of the adhesive can be seen herein.

In accordance with a concomitant mode of the invention, the technical joining connections are formed during thermal treatment. Preferably, the adhesive and the bonding agent are predominantly evaporated and, in particular, a passivation layer is produced through the use of the passivating substance. A high-temperature vacuum process is preferred for the thermal treatment, with the adhesive and/or the bonding agent being evaporated at temperatures of below 200° C. The brazing material in this case only begins to liquefy at higher temperatures (from approximately 450° C.), so that the passivation layer is formed even before this liquefaction of the brazing material, and a flow of brazing material beyond the passivation layer or a settling of brazing material in the region of the passivation layer is prevented.

Other features which are considered as characteristic for the invention are set forth in the appended claims, the features of which can be combined with one another in any way desired.

Although the invention is illustrated and described herein as embodied in a catalyst carrier body with a passivation layer and a method for producing the same, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a set of six elevational, sectional and perspective views diagrammatically illustrating a sequence of production steps of a method according to the invention;

FIG. 2 is an exploded perspective view showing a construction of a catalyst carrier body;

FIG. 3 is an enlarged, fragmentary, sectional view of another embodiment of a catalyst carrier body;

FIG. 4 is an exploded perspective view of a further embodiment of a catalyst carrier body;

FIG. 5 is an enlarged, fragmentary, sectional view of an embodiment of a catalyst carrier body with technical joining connections;

FIG. 6 is an elevational view illustrating a blast-cutting operation for generating a passivation layer; and

FIG. 7 is an enlarged sectional view of a portion VII of FIG. 6 showing the passivation layer.

### DESCRIPTION OF THE PREFERRED EMBODIMENTS

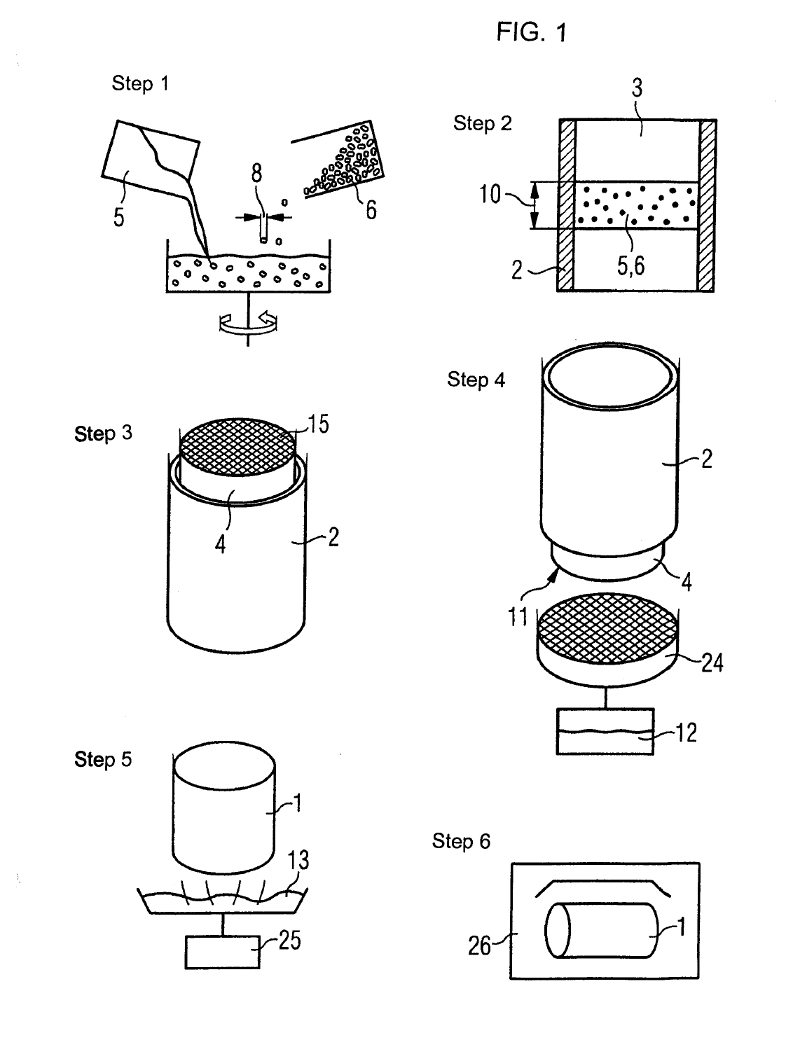

Referring now to the figures of the drawings in detail and first, particularly, to FIG. 1 thereof, there is seen a diagrammatic illustration of a sequence of an embodiment of the method according to the invention for producing a catalyst carrier body 1. Step 1 in this case illustrates blending and/or mixing of an adhesive 5 with a passivating substance 6. The passivating substance 6 is pulverulent and is, in particular, aluminum oxide (preferably plate-shaped particles) with a mean grain diameter 8 of 0.3 μm to 1.5 μm. The two substances are distributed uniformly with one another, for example by using an agitator or the like.

In step 2, a housing 2 is provided on its inside or inner surface 3 with a mixture of the adhesive 5 and of the passivating substance 6. The housing 2 which is illustrated in this case is shown in section.

Step 3 shows how a honeycomb body 4 is inserted at least partially into the housing 2. The honeycomb body 4 is preferably a metallic honeycomb body 4 and the housing 2 is also preferably made from metal.

Step 4 shows one possibility of how a bonding agent 12 can be introduced into inner regions of the honeycomb body 4 or of the housing 2. The bonding agent 12 in this case is introduced into the honeycomb body 4, for example using a capillary plunger or a distributor 24, in such a way that the distributor 24 comes into contact with an end face 11 of the honeycomb body 4. The distributor 24 has a multiplicity of passages in which the bonding agent 12 has located itself. Upon contact with the honeycomb body 4, the bonding agent 12 rises into passages 15 (see Step 3) as a result of a capillary effect, thus wetting regions to be subsequently provided with brazing material.

Step 5 shows a fluidized bed 25, through the use of which pulverulent brazing material 13 is injected into inner regions of the catalyst carrier body 1. The brazing material 13 in this case remains adhering to the non-illustrated bonding agent 12.

Step 6 diagrammatically shows a catalyst carrier body 1 in a furnace 26. In this case, a thermal treatment of the catalyst carrier body is carried out, in which, initially, the introduced adhesive 5 is evaporated and a passivation layer is formed, before the brazing material 13 liquefies. After the thermal treatment or during the cooling of the catalyst carrier body, the previously liquid brazing material solidifies, and the individual components of the catalyst carrier body are connected to one another. This last method step preferably involves high-temperature vacuum brazing.

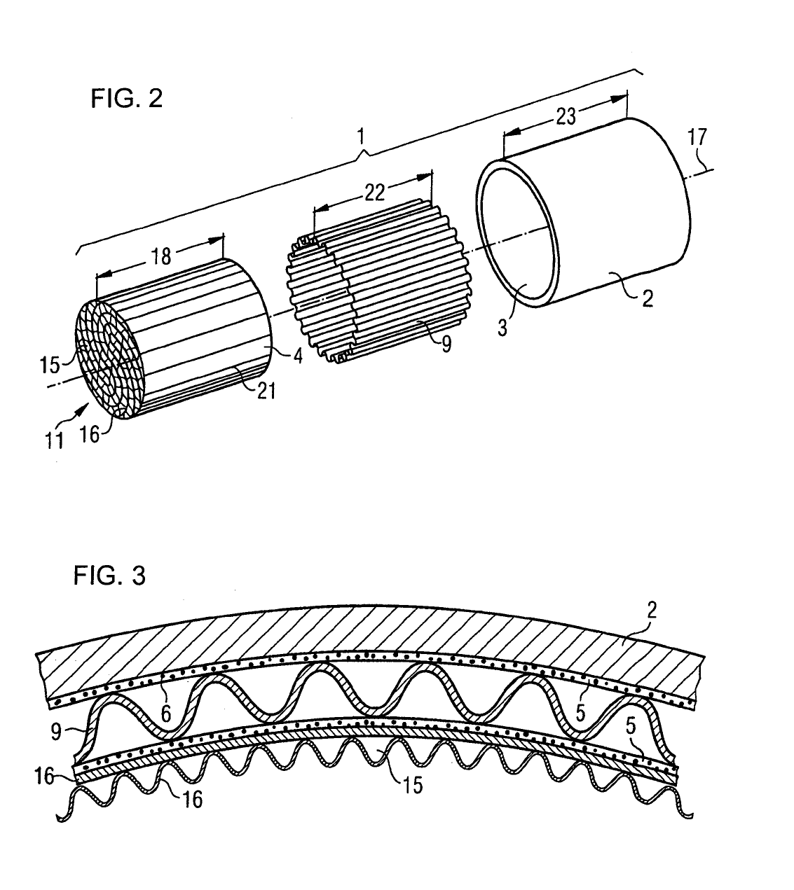

FIG. 2 diagrammatically shows an embodiment of a catalyst carrier body 1 with a sleeve 9, in an exploded illustration. A first component of the catalyst carrier body is the honeycomb body 4. The latter includes a multiplicity of metallic sheet metal layers 16 which are constructed to be partly smooth and partly structured and have been layered alternately and subsequently wound or intertwined with one another. The sheet metal layers 16 in this case have a thickness which is preferably less than 50 μm, in particular less than 20 μm, and preferably less than 15 μm. With regard to the production or configuration of the sheet metal layers for such a honeycomb body 4, reference may be made at this juncture to European Patent Application 0 245 737 A1, corresponding to U.S. Pat. Nos. 4,803,189, 4,832,998, 4,923,109 and 4,946,822; International Publication No. WO 90/03220, corresponding to U.S. Pat. Nos. 5,105,539 and 5,135,794; and German Patent DE 37 43 723 C1, the contents of which are fully incorporated herein by reference. In the illustrated embodiment, the sheet metal layers 16 are wound in an approximately S-shaped manner, and ends 21 of the sheet metal layers 16 can be seen at the periphery. Due to the structuring of some sheet metal sheets 16, passages 15 are formed, which extend substantially or approximately parallel to an axis 17 of the catalyst carrier body 1 and are delimited by the end faces 11 of the honeycomb body 4. In other words, the passages 15 correspond substantially or approximately to a length 18 of the honeycomb body 4.

The catalyst carrier body 1 is delimited outwardly by the housing 2 which has an extent 23 in the direction of the axis 17. The sleeve 9 which is disposed between the honeycomb body 4 and the housing 2 has an extent 22 in the direction of an axis 17. In order to produce such a catalyst carrier body 1, first, the honeycomb body 4 and the sleeve 9 are produced separately, the honeycomb body 4 subsequently being introduced into the sleeve. The non-illustrated adhesive 5 having the passivating substance 6, which is provided on the inside 3 of the housing 2, initially ensures fixing within the housing 2 immediately after the sleeve 9 is pushed in together with the honeycomb body 4. Brazing of the catalyst carrier body 1 on the end face and concluding thermal treatment are subsequently carried out, in which technical joining connections are produced that are not positioned in the region of the non-illustrated previously applied adhesive 5. In principle, the configuration of the catalyst carrier body 1 in terms of the length 18 of the honeycomb body 4, of the extent 22 of the sleeve 9 and/or of the extent 23 of the housing 2 is freely selectable, so that not all components have to be flush with one another at the end faces 11.

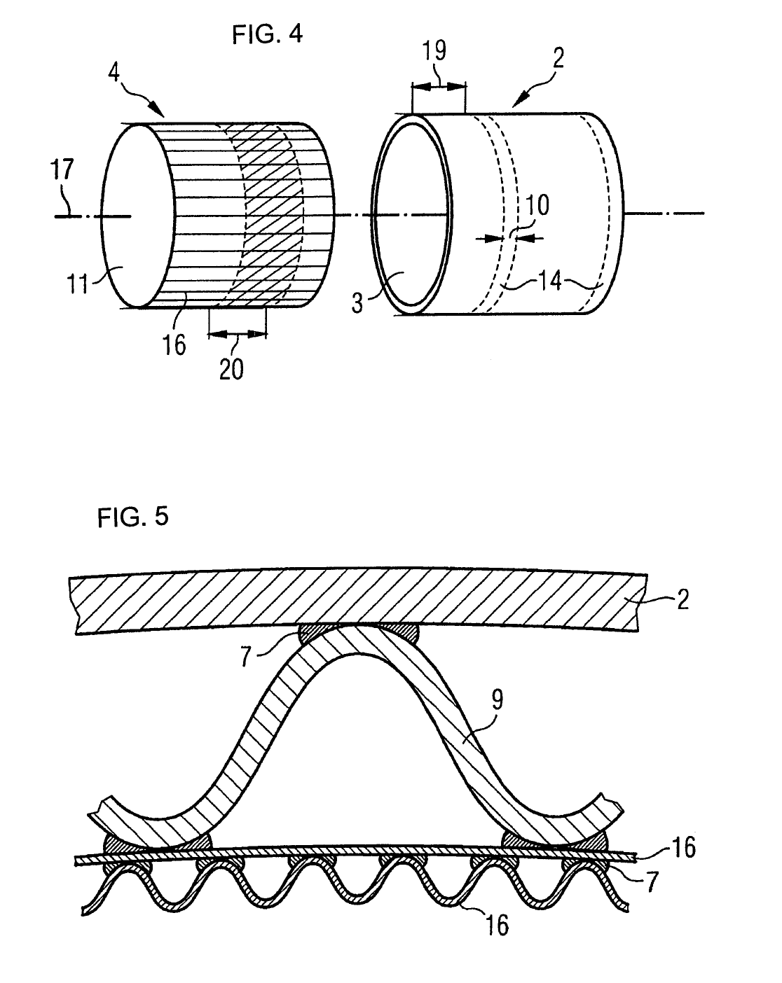

FIG. 3 shows a view of a portion of a catalyst carrier body 1 in section. This figure partially illustrates a housing 2 and a honeycomb body 4 (identified by components 15 and 16) formed from sheet metal layers 16 and having passages 15, with a sleeve 9 being disposed between the housing 2 and the honeycomb body 4. The illustrated section lies in a region of the catalyst carrier body 1 in which no connections are desired between the sleeve 9 and the housing 2 or the honeycomb body 4. In this region, therefore, in each case adhesive 5 having a passivating substance 6 is provided between the sleeve 9 and the housing 2 and between the sleeve 9 and the sheet metal layers 16. The embodiment shown herein constitutes virtually a semi-finished product. After the thermal treatment of the catalyst carrier body 1, a continuous passivation layer 14 (see FIG. 4) is formed from the passivating substance 6 between the sleeve 9 and the adjacent components 2, 4.

FIG. 4 is a perspective view of a further embodiment of a catalyst carrier body 1 including a honeycomb body 4 and a housing 2. The honeycomb body 4 is again constructed with a plurality of sheet metal layers 16. A tying or connection region 20 of the honeycomb body 4 to the housing 2 in this case is illustrated by hatching. The tying region 20 is the region in which a technical joining connection of the honeycomb body 4 or of the sheet metal layers 16 to the housing 2 is subsequently effected. Moreover, the adhesive 5 including the passivating substance 6 was provided on the inside 3 of the housing 2 so that, during the subsequent thermal treatment, passivation layers 14 running completely around in strip form and having a width 10 (also see FIG. 1, Step 2) which is smaller than 10 mm are generated. As is evident, the passivation layers 14 are disposed in such a way that they delimit the tying region 20 after the honeycomb body 4 has been pushed completely into the housing 2. This prevents auxiliary or process materials for the formation of technical joining connections from flowing beyond the limits of the tying region 20 and from causing undesirable connections there. While one passivation layer 14 is disposed directly at one end face 11 of the honeycomb body 4, the other passivation layer 14 is disposed at a distance 19 from an end face 11, in the direction of the axis 17.

FIG. 5 shows a further view of a portion of an embodiment of a catalyst carrier body with a housing 2, with a sleeve 9 and with sheet metal layers 16 forming a honeycomb body 4. This figure is intended particularly to illustrate the formation of technical joining connections 7 which are preferably formed in the contact regions of the components 2, 9, 16 disposed adjacently one another. In this case, the formation of such connections 7 takes place solely in the tying region 20, since there is no passivation layer 14 provided therein.

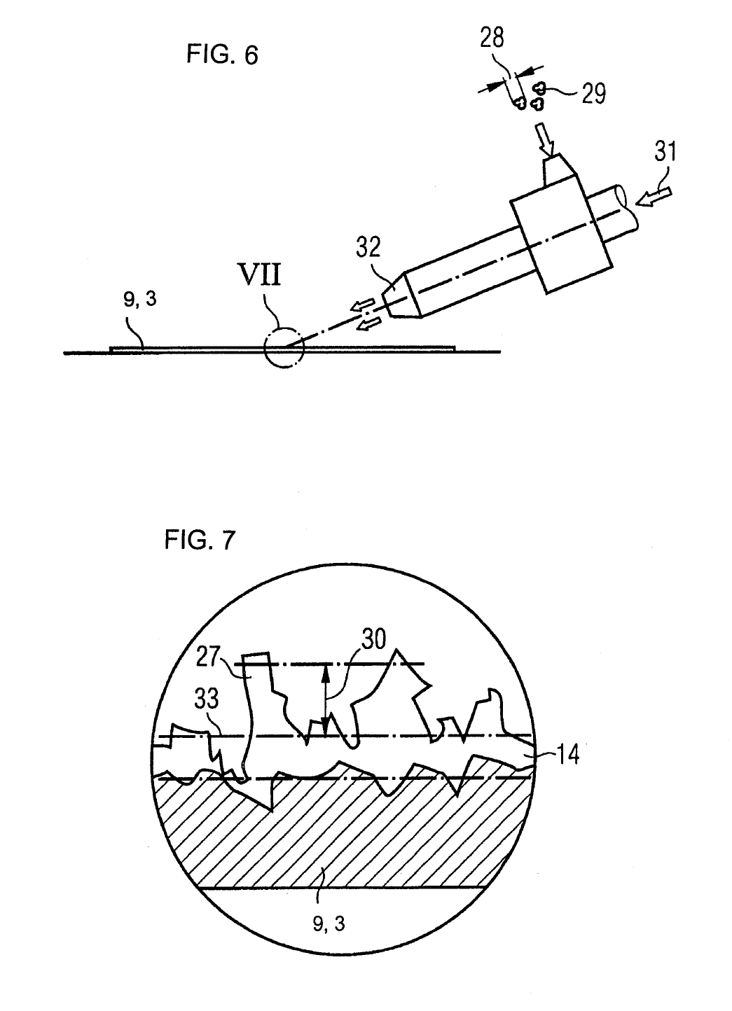

FIG. 6 is a diagrammatic illustration of a blast-cutting operation for generating the passivation layer. Corundum particles 29 with a size 28 of 10 μm to 20 μm are blasted onto a sleeve 9 (or onto the inside 3 of the housing 2) through the use of a nozzle 32. For this purpose, an energy carrier 31 such as, for example, air or a liquid, to which the corundum particles 29 are supplied, is used. The latter are entrained and impinge onto the surface of the sleeve 9 or the inside 3. In this case, on one hand, the surface of the sleeve 9 or the inside 3 is scored, stripped off, etc. but, on the other hand, splitting of the corundum particles and settlement of subfragments on the roughened surface also take place.

This surface of the sleeve 9 or the inside 3 with the passivation layer 14 is illustrated diagrammatically in FIG. 7. The passivation layer 14 includes a multiplicity of separate or isolated crystal agglomerations 27 having an averaged height 30 which is in the range of 0.3 to 1.5 μm. The term “height 30” means the amount by which the crystal agglomerations 27 project with respect to a surrounding level 33 of the passivation layer 14.

The method described herein is particularly simple and cost-effective, so that it is predestined for use in series manufacture. The catalyst carrier bodies resulting from this method are capable, over a long period of time, of withstanding the thermal and dynamic loads in the exhaust system of a motor vehicle.

We claim:

1. A catalyst carrier body, comprising:
at least one housing having an inside;
a honeycomb body connected to said inside of said at least one housing by technical joining in a tying region; and
at least one passivation layer delimiting said tying region, said passivation layer including a multiplicity of separate crystal agglomerations with an averaged height lying in a range of 0.3 to 1.5 μm.

2. The catalyst carrier body according to claim 1, wherein said crystal agglomerations are disposed on said inside of said housing.

3. The catalyst carrier body according to claim 2, wherein said inside of said housing is roughened in the vicinity of said passivation layer.

4. The catalyst carrier body according to claim 1, further comprising at least one sleeve disposed between said housing and said honeycomb body, said crystal agglomerations being disposed on said at least one sleeve.

5. The catalyst carrier body according to claim 4, wherein said sleeve is roughened in the vicinity of said passivation layer.
